(19) United States
(12) Patent Application Publication
(10) Pub. No.: US 2025/0118749 A1
(43) Pub. Date: Apr. 10, 2025

(54) COMPOSITE ANODE MATERIAL AND METHOD FOR PRODUCING SAME

(71) Applicant: Talga Technologies Limited, Histon (GB)

(72) Inventors: Claudio CAPIGLIA, Osaka (JP); Sai SHIVAREDDY, Cambridgeshire (GB)

(21) Appl. No.: 18/988,164

(22) Filed: Dec. 19, 2024

Related U.S. Application Data
(63) Continuation of application No. PCT/IB2023/056737, filed on Jun. 29, 2023.

(30) Foreign Application Priority Data
Jun. 29, 2022 (AU) 2022901821

(51) Int. Cl. H01M 4/583; C01B 32/205; H01M 4/02; H01M 4/04; H01M 4/36

(52) U.S. Cl. CPC H01M 4/583; C01B 32/205; H01M 4/0471; H01M 4/362; C01P 2006/12; H01M 2004/021; H01M 2004/027

(57) ABSTRACT

A method for the production of a composite anode material, the method comprising the method steps of:
(i) Subjecting a graphitic material to a coating step in which the graphitic material is coated with a carbon matrix;
(ii) Passing the product of step (i) to a shaping step to produce shaped composites; and
(iii) Thermal treatment of the composites of step (ii), thereby producing a composite anode material comprising a plurality of graphitic particles held within the carbon matrix and about which is provided an amorphous carbon shell.

The composite anode material is also described.

### FIELD OF THE INVENTION

The present invention relates to a composite anode material and method for producing same. More particularly, the composite anode material of the present invention is intended for use as an anode material in lithium-ion batteries.

In one highly preferred form, the present invention further relates to a composite anode material comprising a graphitic material coated by a carbon matrix, about which is provided an external amorphous carbon shell.

The present invention still further relates to a method for producing a composite anode material as described herein.

### BACKGROUND ART

Presently, typical methods for the manufacture of graphitic anodes for use in lithium-ion batteries utilise graphitic materials that are relatively coarse, having a D₅₀ of, for example, greater than 10 μm. Typical manufacturing processes for these materials involve the initial spheronisation and subsequent coating of particles. In such cases, spheronisation followed by both dry or wet carbon coating methods are available for use. However, to date, there are no industrial methods available to spheronise and dry coat particles with a D₅₀ of less than 5 μm.

Dry coating typically enables the cost of production to be reduced when compared with wet coating technologies (i.e. that typically use organic solvents).

The use of such relatively coarse graphitic materials in producing a graphitic anode brings with it the need to reduce the size of the graphitic material prior to coating, for example utilising grinding steps such as is required to reduce flake graphite to a size of 20 μm or less than 10 μm. This again increases the cost of the process when compared to a process in which it would not be necessary to reduce the size of a graphitic particle.

Smaller graphitic particles with a D₅₀ of less than 5 μm have previously been used in the manufacture of graphitic anodes which are typically amorphous/not particularly crystalline. This characteristic makes such graphitic particles generally unsuitable for use in a process of anode manufacturing for lithium-ion batteries. Additionally, prior art processes of this type utilise fines, and create with the fines a flake sized material that is then required to be crushed. The final size or grain diameter of such methods is typically 15 to 20 μm.

It would be advantageous if graphitic materials of any particle size could be utilised as the starting material for the production of a composite anode material.

The composite material and method of the present invention have as one object thereof to overcome substantially one or more of the abovementioned problems associated with prior art processes, or to at least provide a useful alternative thereto.

The preceding discussion of the background art is intended to facilitate an understanding of the present invention only. This discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the term “softening point” or “pitch softening point” will be understood to refer to the temperature at which the pitch flows a predetermined distance under carefully defined conditions as a consequence of heating, such as may be measured in accordance with ISO 540-2:2007.

Throughout the specification and claims, unless the context requires otherwise, D₅₀ and variations thereof such as Dv50, are to be understood to refer to the median value of the particle size distribution. Put another way, it is the value of the particle diameter at 50% in a cumulative distribution. For example, if the D₅₀ of a sample is a value X, 50% of the particles in that sample are smaller than the value X, and 50% of the particles in that sample are larger than the value X. Similarly, D₁₀ is the value of the particle size at 10% in a cumulative distribution and D₉₀ is the value of the particle size at 90% in a cumulative distribution.

Throughout the specification and claims it is to be understood that the term “Cg” indicates carbon in graphitic form.

Throughout the specification and claims, unless the context requires otherwise, the term P₈₀ it is to be understood to refer to an 80% cumulative passing size.

The term “relative” or “relatively” used herein in respect of a feature of the invention is intended to indicate comparison to that feature in the prior art and the typical characteristics of that feature in the prior art, unless the context clearly indicates or requires otherwise.

References to particle surface area measurements throughout the specification and claims are to be understood with reference to the BET or Bernauer-Emmett-Teller method or theory, in which gas adsorption data is evaluated and used to generate a specific surface area result expressed in units of area per mass of sample (m²/g).

It is to be understood that the ranges provided herein include the stated range and any value or sub-range within the stated range. For example, a range from about 1 micrometer (μm) to about 2 μm should be interpreted to include not only the explicitly recited limits of from about 1 μm to about 2 μm, but also to include individual values, such as about 1.2 μm, about 1.5 μm, about 1.8 μm, etc., and sub-ranges, such as from about 1.1 μm to about 1.9 μm, from about 1.25 μm to about 1.75 μm, etc. Furthermore, when “about” and/or “substantially” are/is utilised to describe a value, they are meant to encompass minor variations (up to +/−10%) from the stated value.

### DISCLOSURE OF THE INVENTION

In accordance with the present invention there is provided a composite anode material comprising a graphitic material coated by a carbon matrix, about which is provided an external amorphous carbon shell.

Preferably, the graphitic material is a graphitic material that has been coated by the carbon matrix and subsequently subjected to a shaping step. The shaping step may preferably be a spheronisation step.

Preferably, the graphitic material is provided in the form of graphite particles that have a D₅₀ of less than about 10 μm. Still preferably, the graphitic material is provided in the form of graphite particles that have a D₅₀ of less than about 6 μm.

In one form, the graphitic material further comprises highly crystalline graphite with a D₅₀ of less than about 10 μm.

The graphite particles are preferably in the form of flake crystalline graphite.

In one form of the present invention the carbon matrix is pitch. The pitch is preferably about 2-15 wt % of the composite anode material.

Preferably, the composite anode material has a D₅₀ of:
a) about 3.5 to 5 μm; or
b) about 4.7 μm.

Preferably, the composite anode material has a surface area (BET) in the range of about 4 to 7 m²/g, for example 4.4 m²/g.

In one form of the invention the purity of the graphitic material is:
a) greater than about 99.92 wt % Cg; or
b) between about 99.95 to 99.97 wt % Cg.

In one form of the present invention, the graphitic material is provided in the form of synthetic graphite. In another form of the present invention the graphitic material is provided in the form of natural graphite with a high crystalline structure. In a further form of the present invention, alloy materials may be used as a precursor to the composite anode material of the present invention.

Preferably, the carbon matrix is provided in the form of an amorphous carbon matrix, a crystalline carbon matrix, or a combination of both an amorphous carbon matrix and a crystalline carbon matrix.

The outside layer of amorphous carbon may further comprise one or more oxides. The one or more oxides may preferably be present in the form of Al₂O₃, TiO₂, ZrO₂, BaTiO₃, MgO, CuO, ZnO, Fe₂O₃, GeO₂, Li₂O, MnO, NiO, or zeolite, or any combination thereof.

Preferably, the oxides have a particle size in the range of about 20 nm to 1 μm.

Preferably, the composite material possesses a level of elastic properties conferred by the presence of one or more of the graphite particles, graphene, few-layer graphene and graphite nanoparticles that may be provided within the amorphous carbon matrix.

In accordance with the present invention there is still further provided an anode composite comprising a composite anode material as described hereinabove.

In accordance with the present invention there is yet still further provided a method for the production of a composite anode material, the method comprising the method steps of:
(i) Subjecting a graphitic material to a coating step in which the graphitic material is coated with a carbon matrix;
(ii) Passing the product of step (i) to a shaping step to produce shaped composites; and
(iii) Thermal treatment of the composites of step (ii), thereby producing a composite anode material comprising a plurality of graphitic particles held within the carbon matrix and about which is provided an amorphous carbon shell.

Preferably, the graphitic material is provided in the form of graphite particles that have a D₅₀ of less than about 10 μm. Still preferably, the graphitic material is provided in the form of graphite particles that have a D₅₀ of less than about 6 μm.

In one form of the present invention the carbon matrix is pitch. Preferably, the pitch is about 2-15 wt %.

Preferably, the agglomeration or coating step (i) is conducted in a mixer.

Preferably, the composite anode material has a D₅₀ of:
a) about 3.5 to 5 μm; or
b) about 4.7 μm.

Preferably, the composite anode material has a surface area (BET) in the range of about 4 to 7 m²/g, for example about 4.4 m²/g.

In one form of the invention the purity of the graphitic material is:
a) greater than about 99.92 wt % Cg; or
b) between about 99.95 to 99.97 wt % Cg.

In one form of the present invention, the graphitic material is provided in the form of synthetic graphite. In another form of the present invention the graphitic material is provided in the form of natural graphite with a high crystalline structure. In a further form of the present invention, alloy materials may be added to the composite anode material of the present invention.

Preferably, the carbon matrix is provided in the form of an amorphous carbon matrix, a crystalline carbon matrix, or a combination of both an amorphous carbon matrix and a crystalline carbon matrix.

The outside layer of amorphous carbon may further comprise one or more oxides. The one or more oxides may preferably be present in the form of Al₂O₃, TiO₂, ZrO₂, BaTiO₃, MgO, CuO, ZnO, Fe₂O₃, GeO₂, Li₂O, MnO, NiO, or zeolite, or any combination thereof.

Preferably, the oxides have a particle size in the range of about 20 nm to 1 μm.

Preferably, the thermal treatment of step (iii) is provided in the form of pyrolysis.

The method of the present invention may further comprise a classification step, either before the process described hereinabove, or following the thermal treatment of step (iii).

Preferably, the graphitic materials of step (i) are provided in the form of crystalline graphite particles.

The thermal treatment of step (iii) is preferably conducted at a temperature in the range of about 850° C. to 1100° C.

Preferably, the thermal treatment step (iii) comprises a profile of heating, holding at temperature, and cooling.

In one form the thermal treatment step (iii) comprises about 8.5 hours heating, about 4 hours holding at 1100° C., and about 5 to 10 hours cooling. Preferably, once cooled the composite anode material is at a temperature of about 100° C. Still preferably, the thermal treatment step (iii) has a total cycle time for the profile of heating, holding at temperature, and cooling of between about 17 to 22 hours.

In a further form the thermal treatment step (iii) preferably comprises:
(i) between about 20 to 60 hours heating;
(ii) between about 30 to 60 hours heating; or
(iii) about 31.5 hours heating.

In this form, the thermal treatment step (iii) preferably has a total cycle time for the profile of heating, holding at temperature, and cooling of:
(i) between about 34 to 74 hours;
(ii) between about 44 to 74 hours; or
(iii) about 45.5 hours.

In one form of the present invention the thermal treatment step (iii) comprises heating conducted at a heating rate of about 2° C./minute. Preferably, this heating rate is applied at least between the temperatures of about 300 to 700° C.

The method for the production of a composite anode material of the present invention may further comprise an initial classification step in which the graphitic material is classified. In one form of the present invention the initial classification step is conducted using an air classifier.

Preferably, the graphitic material is classified into more than one fraction, with a fraction below about 1 to 2 μm being cut and the remaining fraction being utilised in step (i).

Still preferably, the remaining fraction is screened to remove particles greater than about 30 μm.

In one form of the present invention the graphitic material is classified into three fractions, including a fine, a medium and a gross fraction, wherein the medium and fine fractions are utilised in step (i).

The method for the production of a composite anode material of the present invention may still further comprise a final classification step. The final classification step preferably removes any composite anode material of greater than about 30 μm.

### BRIEF DESCRIPTION OF THE DRAWINGS

The present invention will now be described, by way of example only, with reference to one embodiment thereof and the accompanying drawings, in which:

FIG. 1 is a conceptual overview of a method for the production of a composite anode material in accordance with the present invention;

FIG. 2 is a diagrammatic representation of a flow sheet for the method for the production of a composite anode material in accordance with the present invention showing each of the process steps that may be employed;

FIG. 3 is a scanning electron micrograph (SEM) of the Applicant's purified graphite material (99.95 wt % Cg) at a magnification of ×4,000, properties of which include a d002 of 3.35, La of >1000 Å and Lc>1000 Å,and which is utilised as the graphitic material of step (i) in the method of the present invention;

FIG. 4 depicts two scanning electron micrograph (SEM) images (×1,000 at left, ×5,000 at right) of the combination of the Applicant's purified graphite material with pitch as a result of the coating step of the method of the present invention;

FIG. 5 depicts two scanning electron micrograph (SEM) images (×1,000 at left, ×5,000 at right) of the product of the shaping step of the method of the present invention; and

FIG. 6 depicts two scanning electron micrographs (SEM) images (×1,000 at left, ×10,000 at right) of the product of the thermal treatment step of the method of the present invention.

### BEST MODE(S) FOR CARRYING OUT THE INVENTION

The present invention provides a composite anode material comprising a graphitic material coated by a carbon matrix, about which is provided an external amorphous carbon shell. The graphitic material is a graphitic material that has first been coated by the carbon matrix and subsequently subjected to a shaping step. The shaping step may be a spheronisation step.

The graphitic material may be provided in the form of graphite particles that have a D₅₀ of less than about 10 μm. For example, the graphitic material is provided in the form of graphite particles that have a D₅₀ of less than about 6 μm.

In one form of the present invention the carbon matrix is pitch. The pitch may be in the range of about 2-15 wt %, for example about 8 wt %.

The composite anode material has a D₅₀ of, for example:
a) about 3.5 to 5 μm; or
b) about 4.7 μm.

The composite anode material has a surface area (BET) in the range of about 4 to 7 m²/g, for example about 4.4 m²/g.

In one form of the invention the purity of the graphitic material is:
a) greater than about 99.92 wt % Cg; or
b) between about 99.95 to 99.97 wt % Cg.

In one form of the present invention the graphitic material is provided in the form of a synthetic graphite. In another form of the present invention the graphitic material is provided in the form of natural graphite with high crystalline structure. In a further form of the present invention, alloy materials may be added to the composite anode material of the present invention.

It is envisaged that the carbon matrix may be provided in the form of an amorphous carbon matrix, a crystalline carbon matrix, or a combination of both an amorphous carbon matrix and a crystalline carbon matrix.

The outside layer of amorphous carbon may further comprise one or more oxides. The one or more oxides may be present in the form of Al₂O₃, TiO₂, ZrO₂, BaTiO₃, MgO, CuO, ZnO, Fe₂O₃, GeO₂, Li₂O, MnO, NiO, or zeolite, or any combination thereof. The oxides have a particle size in the range of about 20 nm to 1 μm.

The composite material possesses a level of elastic properties conferred by the presence of one or more of the graphite particles, graphene, few-layer graphene and graphite nanoparticles that may be provided within the amorphous carbon matrix.

The present invention further provides an anode composite comprising a composite anode material as described hereinabove.

The present invention still further provides a method for the production of a composite anode material, the method comprising the method steps of:
(i) Subjecting a graphitic material to a coating step in which the graphitic material is coated with a carbon matrix;
(ii) Passing the product of step (i) to a shaping step to produce shaped composites; and
(iii) Thermal treatment of the composites of step (ii), thereby producing a composite anode material comprising a plurality of graphitic particles held within the carbon matrix and about which is provided an amorphous carbon shell.

The graphitic material is provided in the form of graphite particles that have a D₅₀ of less than about 10 μm. For example, the graphitic material is provided in the form of graphite particles that have a D₅₀ of less than about 6 μm.

In one form of the present invention the carbon matrix is pitch. The pitch may be in the range of 2-15 wt %, for example about 8 wt %.

The agglomeration or coating step (i) is conducted in a mixer.

The composite anode material has a D₅₀ of, for example:
a) about 3.5 to 5 μm; or
b) about 4.7 μm.

In one form the composite anode material has a surface area (BET) in the range of about 4 to 7 m²/g, for example of about 4.4 m²/g.

In a further form of the invention the purity of the graphitic material is:
a) greater than about 99.92 wt % Cg; or
b) between about 99.95 to 99.97 wt % Cg.

In one form of the present invention the graphitic material is provided in the form of a synthetic graphite. In another form of the present invention the graphitic material is provided in the form of natural graphite with high crystalline structure. In a further form of the present invention, alloy materials may be added to the composite anode material of the present invention.

The carbon matrix is provided, for example, in the form of an amorphous carbon matrix, a crystalline carbon matrix, or a combination of both an amorphous carbon matrix and a crystalline carbon matrix.

The outside layer of amorphous carbon may further comprise one or more oxides. The one or more oxides may be present in the form of Al₂O₃, TiO₂, ZrO₂, BaTiO₃, MgO, CuO, ZnO, Fe₂O₃, GeO₂, Li₂O, MnO, NiO, or zeolite, or any combination thereof. The oxides have a particle size in the range of about 20 nm to 1 μm.

The thermal treatment of step (iii) is provided, for example, in the form of pyrolysis.

The method of the present invention may further comprise a classification step following the thermal treatment of step (iii).

In one form the graphitic materials of step (i) are provided in the form of pre-exfoliated graphite particles.

The thermal treatment of step (iii) may be conducted at a temperature in the range of about 850° C. to 1100° C.

The thermal treatment step (iii), in one form, comprises a profile of heating, holding at temperature, and cooling.

The thermal treatment step (iii) comprises, for example, about 8.5 hours heating, about 4 hours holding at 1100° C., and about 5 to 10 hours cooling. Once cooled the composite anode material may be at a temperature of about 100° C. and the thermal treatment step (iii) has a total cycle time for the profile of heating, holding at temperature, and cooling of between about 17 to 22 hours.

In a further form the thermal treatment step (iii) comprises:
(i) between about 20 to 60 hours heating;
(ii) between about 30 to 60 hours heating; or
(iii) about 31.5 hours heating.

In this further form, the thermal treatment step (iii) has a total cycle time for the profile of heating, holding at temperature, and cooling of:
(i) between about 34 to 74 hours;
(ii) between about 44 to 74 hours; or
(iii) about 45.5 hours.

In one form of the present invention the thermal treatment step (iii) comprises heating conducted at a heating rate of about 2° C./minute. For example, this heating rate is applied at least between the temperatures of about 300 to 700° C.

The method for the production of a composite anode material of the present invention may further comprise an initial classification step in which the graphitic material is classified. In one form of the present invention the initial classification step is conducted using an air classifier.

The graphitic material is classified, for example, into more than one fraction, with a fraction below about 1 to 2 μm being cut and the remaining fraction being utilised in step (i), and the remaining fraction is screened to remove particles greater than about 30 μm.

In one form of the present invention, the graphitic material is classified into three fractions, including a fine, a medium and a gross fraction, wherein the medium and fine fractions are utilised in step (i).

The method for the production of a composite anode material of the present invention may still further comprise a final classification step. The final classification step is intended to remove any composite anode material of greater than about 30 μm.

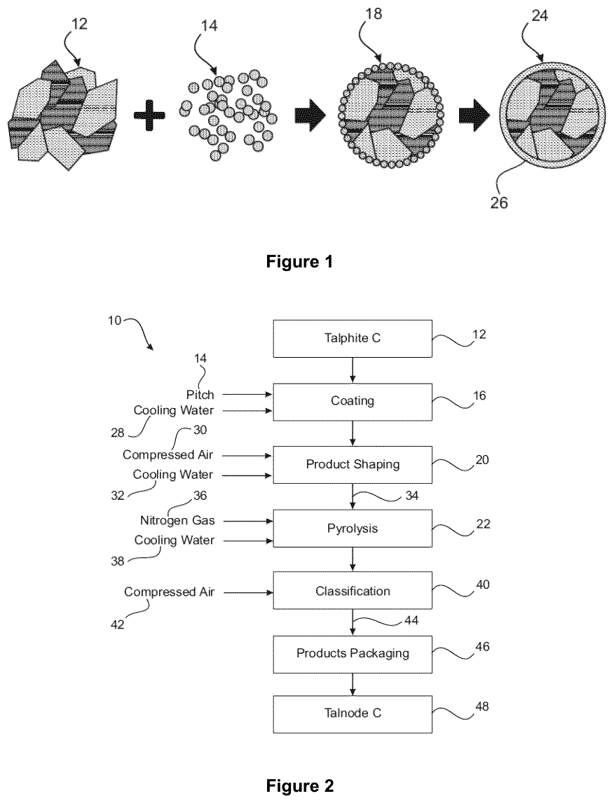

In FIG. 1 there is shown a conceptual overview of a process 10, shown in FIG. 2, in accordance with the present invention. In FIG. 1 there is shown a graphitic material, for example a purified graphite 12 with a grading of about 99.92 to 99.95 wt % Cg, as a starting material (also referred to herein as ‘Talphite-C’). The purified graphite 12 is coated with a carbon matrix, for example pitch 14, in an agglomeration or coating step 16, providing a carbon coated graphitic material composite 18. The coated graphitic material composite 18 is passed to a shaping step 20 and a thermal treatment step 22, providing a composite anode material 24. The composite anode material 24 has an amorphous carbon shell 26 provided thereabout.

With specific reference to FIG. 2, the purified graphite 12 is, if considered necessary, passed to an initial classification step (not shown) by which a highly crystalline starting material may largely be ensured. An exemplary composition for the purified graphite is D₁₀ 2.342, D₅₀ 5.441 and D₉₀ 11.55. This initial classification step is undertaken, for example, using a machine that utilises airflow to divide the product into three fractions, being fine, medium and gross fractions. The fine fraction, for example below about 1 to 2 μm, is set aside, and the medium and gross fractions in the range of about 2 to 15 μm, having a D₅₀ of less than about 10 μm, and for example of about 6 μm, are passed to the coating step 16. If any particles of 30 μm or above are present these are screened out. The purity of the fractions passed to the coating step 16 may improve to about 99.97 wt % Cg through this process.

The initial classification step may, for example, be conducted using a HIPREC classifier HPC-1 Microtrac MT3300EX II, commercially available from Powder Systems Co., Ltd.

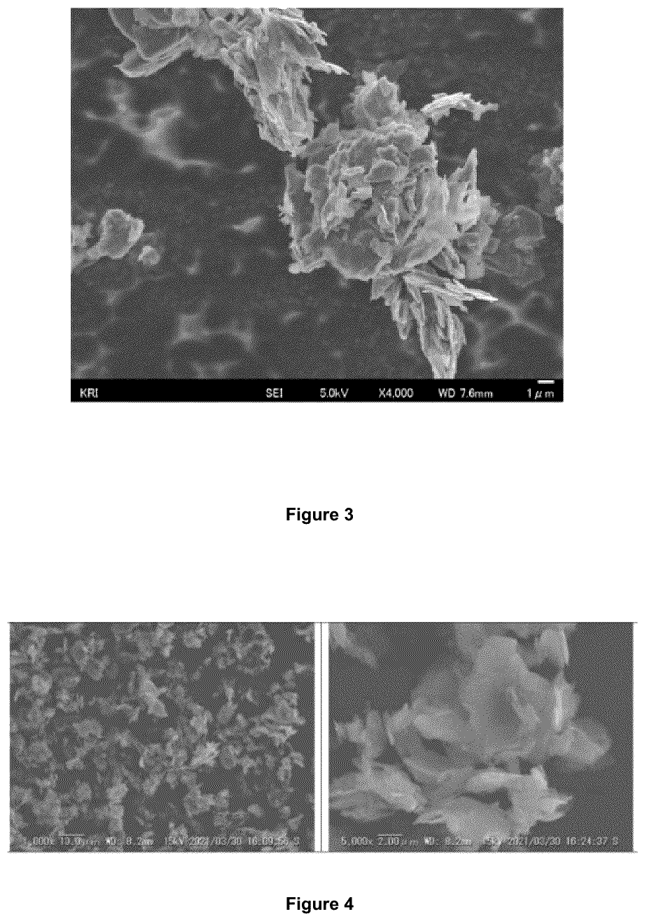

In FIG. 3 there is shown a scanning electron micrograph (SEM) of the purified graphite material 12 (99.95 wt % Cg) at a magnification of ×4,000, properties of which include a d002 of 3.36, La of >1000 and Lc >1000, and which is utilised as the graphitic material in the coating step 16 described immediately above.

In the coating step 16 the purified graphite 12, post-classification if required, is blended with a carbon matrix, for example pitch 14, in a mixer. Cooling water 28 is also introduced to the coating step 16. The pitch 14 is provided in an amount in the range of 2-15 wt %, for example 8 wt %. It is understood by the Applicant that pitch contents toward the high end of the range 2-15 wt % may bring improved high temperature performance for the composite anode material of the present invention.

The pitch 14 may be milled to a powder, for example to a P₈₀ of about 2 μm, prior to introduction to the purified graphite 12 in the coating step 16.

The coating step 16 may, for example, be conducted in a Balance Gran or Eirich mixer, such as a BG-25L mixer, utilising 3.7 kW×4P (Rated 14.2 A) chopper and 0.4 KW×4P (Rated 2.05 A) scraper.

Suitable conditions for the coating step 16 are CCW rpm 1150/CW 30 rpm/15 minutes residence time/loading 3.23 kg, comprised of 3 kg purified graphite 12 and 0.23 kg pitch 14.

In FIG. 4 there are shown two scanning electron micrograph (SEM) images (×1,000 at left, ×5,000 at right) of the carbon coated graphitic material composite 18.

The carbon coated graphitic material composite 18 from the coating step 16 is passed to the shaping step 20, in which the composite 18 is spheronised in a spheronising machine, for example Nara, Newman ESSER or the like machines. Compressed air 30 and cooling water 32 are also introduced to the shaping step 20. A spheronised product 34 is discharged under pressure from the spheronising machine, and product laden off-gas flows into a cyclone, with the cyclone underflow discharging into a storage vessel.

The shaping step 20 may, for example, be conducted at room temperature at first instance, in a Nara NHS-3 2 L unit. It is envisaged that an NHS-5 unit may similarly be utilised. Suitable conditions for the shaping step 20 are 4000 rpm/800 gr batch/10 minutes residence time. The shaping step 20 also produces a proportion of fine waste particles that are collected in a baghouse. This proportion of fine waste particles may be in the order of 5% of the introduced composite 18.

The shaping step 20 may, in one form of the present invention, be run at an elevated temperature. The elevated temperature is at or above the pitch softening temperature. The pitch softening temperature is expected to differ for different pitches. The pitch softening temperatures for pitches employed by the Applicants in test work relating to the present invention fall between about 110 to 250° C., and for example are 118° C. and 250° C.

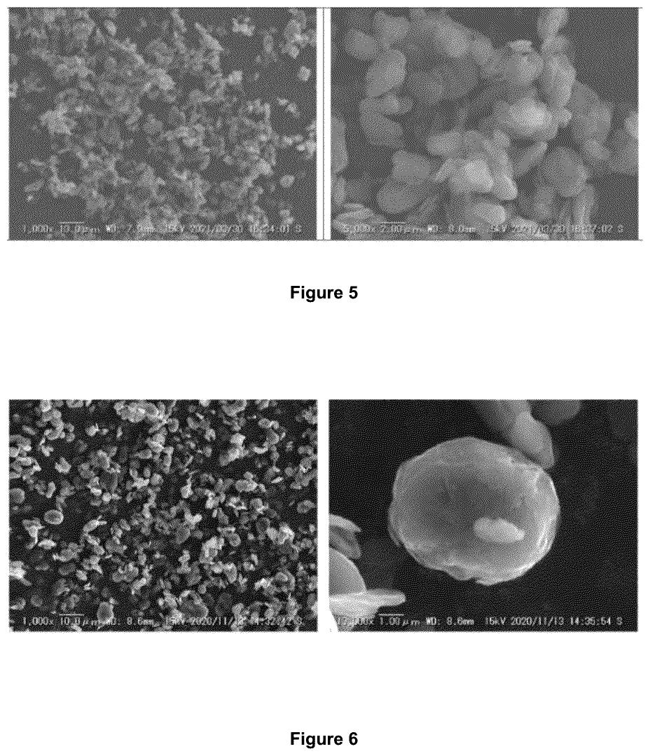

In FIG. 5 there are shown two scanning electron micrograph (SEM) images (×1,000 at left, ×5,000 at right) of the spheronised product 34 of the shaping step 20.

The spheronised product 34 is passed to the thermal treatment step 22, for example a pyrolysis or carbonisation process. Also introduced to the thermal treatment step 22 is nitrogen gas 36 and cooling water 38. After carbonisation the temperature is cooled, providing the composite anode material 24 (also referenced herein as ‘Talnode-C’).

The process of carbonisation may, for example, comprise a profile of heating, holding at temperature, and cooling. This profile may comprise, for example, about 8.5 hours heating, about 4 hours holding at 1100° C., and about 5 to 10 hours cooling. Once cooled the composite anode material may be at a temperature of about 100° C. and the thermal treatment step (iii) has a total cycle time for the profile of heating, holding at temperature, and cooling of between about 17 to 22 hours. Nitrogen gas 36 flow is, for example, provided at about 27 m³/h.

In FIG. 6 there are shown two scanning electron micrographs (SEM) images (×1,000 at left, ×10,000 at right) of the composite anode material 24 product of the thermal treatment step 22.

A final classification step 40 receives the composite anode material 24 from the thermal treatment step 22. The final classification step 40 is, for example, conducted in a magnetic filter and compressed air 42 is provided as an input to the final classification step 40. A filtered composite anode material 44 is produced from this step 40, is passed to a packaging step 46, thereby providing a final packaged composite anode material 48.

The process of the present invention may be better understood with reference to the following non-limiting examples.

### EXAMPLES

Table A below provides an example of an appropriate purified graphite 12 for use in/as used in the method of the present invention, whilst Table B provides the elemental analysis thereof.

TABLE A

| Property | Value | | Method |
|---|---|---|---|
| Carbon Content | >99.9% | | LECO (C %, S %). Loss of |
| | | | Ignition (LOI) |
| Surface Area | 2-9 | m²/g | Bernauer-Emmett-Teller (BET) |
| Particle size | 3-15 | μm | Particle size analyzer |
| D₁₀ | 1~3 | μm | |
| D₅₀ | 4~6 | μm | |
| D₉₀ | 7-10 | μm | |
| Bulk Density | 0.2-1 | g/cc | Bulk density apparatus |
| d1002 | >3.35 | Å | XRD |
| Lc | >1000 | Å | |
| La | >1000 | Å | |

TABLE B

| C | Al | Ca | Cu | Fe | K | Mg | Mn | Si | S | ELEMENTS |
|---|---|---|---|---|---|---|---|---|---|---|
| >99.9% | 3.3 | 7.4 | 7.3 | 26.7 | 5.7 | 2.9 | 0.2 | <0.1 | 37 | ppm |

Table C below provides details of testing conducted regarding the shaping step 20 described hereinabove, wherein carbon-coated graphitic material composite 18 has a particle size in the range of 5.9 to 6.2 μm and a tap density of 443 to 503 kg/m³, is spheronised. As noted above, the shaping step 20 is conducted in a Nara NHS-3 2 L unit with 4000 rpm/800 gr batch/10 minutes residence time.

TABLE C

| | Amount | Recovery | Particle | Tap Density |
|---|---|---|---|---|
| Processing No. | Recovered | rate (%) | size D₅₀ | [Kg/m³] |
| Run - 1~403 | 307.3 kg | 95.3 | 3.9~4.1 | 727~758 |

It was observed that the average particle size of the spheronised product is about 2 μm smaller than that of the carbon-coated graphitic material composite 18 fed to it, and the tap density is about 250 to 280 kg/m³ larger.

Additional test work was undertaken to determine if the throughput capacity of the Nara NHS-3 2 L unit could be increased, which would allow a greater volume of material to be processed in any given period. Results indicated that increasing capacity relative to the testing reported immediately above improved spheronisation and tap density increased. These indicative results include the following:
T-3: Basic line: 800 gr—10 minutes. Tap density 827 gr/cc
T-14: 1200 gr—6.5 minutes. Tap density 843 gr/cc (from Talphite-C classified)
T-18: 800 gr—7 minutes. Tap density 785 gr/cc (from Talphite-C classified)
T-19: 800 gr—7 minutes. Tap density 759 gr/cc

Table D below provides details of the characteristics of the composite anode material of the present invention, including capacity testing (conducted with a voltage of 0.005V to 2V, and current of 0.1 C A).

TABLE D

| | | | | | | | | True |
|---|---|---|---|---|---|---|---|---|
| Dv10 | Dv50 | Dv90 | Tap | BET | Ash | XRD | | Density |
| μm | μm | μm | g/cm³ | m²/g | % | D002 Å | DOG | g/cm³ |
| 2.5 | 4.7 | 8.5 | 1.0 | 4.4 | 0.033 | 3.358 | 95.4% | 2.24 |

| Capacity | Efficiency | S | Fe | Si | Na | K |
|---|---|---|---|---|---|---|
| mAh/g | % | ppm | ppm | ppm | ppm | ppm |
| 369 | 91.3 | 120.6 | 12.5 | 9.2 | 19.1 | 16.0 |

As can be seen from the above description, the composite anode material and method for producing same of the present invention are intended to allow a composite anode material to be created from a starting graphitic material of any size. As such, whilst prior art materials and methods utilised coarser materials, the composite anode material and method for producing same of the present invention are such that graphitic starting materials of less than about 10 μm, and particularly less than about 6 μm may be utilised. Starting materials of this small size have previously not been considered appropriate as they were not suitable for what were understood to be the conventional manufacturing processes.

It is understood by the Applicant that the coating of the graphitic starting material with the carbon matrix prior to the shaping step is of particular importance in realising the advantages of the present invention. The Applicant's testing with purified graphitic material of less than about 10 μm, wherein the shaping step, for example spheronisation, is conducted prior to the coating step has shown that the surface area increases dramatically. For example, this surface area increase has been in the order of 4-6 m²/g to 50 m²/g. Such an increase in the particle surface area is undesirable when preparing an anode material.

It is envisaged that the method of the present invention is such that synthetic graphite is a suitable graphitic material. Further, it is envisaged that alloy materials, including silicon, SiO, magnesium, antimony and the like, may be incorporated into the composite anode material of the present invention.

Modifications and variations such as would be apparent to the skilled addressee are considered to fall within the scope of the present invention.

1.-48. (canceled)

49. A composite anode material comprising a graphitic material in the form of a plurality of carbon coated graphite particles, wherein each graphite particle is coated by a carbon matrix, about which is provided an external amorphous carbon shell, wherein the composite anode material has a D₅₀ of about 3.5 to 5 μm.

50. The composite anode material of claim 49, wherein the graphitic material is a plurality of graphite particles that have been coated by the carbon matrix and subsequently subjected to a shaping step.

51. The composite anode material of claim 49, wherein the graphite particles are in the form of flake crystalline graphite.

52. The composite anode material of claim 49, wherein the carbon matrix is pitch.

53. The composite anode material of claim 52, wherein the pitch is about 2-15 wt % of the composite anode material.

54. The composite anode material of claim 49, wherein the composite anode material has a D₅₀ of about 4.7 μm.

55. The composite anode material of claim 49, wherein the composite anode material has a surface area (BET):
(i) in the range of about 4 to 7 m²/g; or
(ii) of about 4.4 m²/g.

56. The composite anode material of claim 49, wherein the purity of the graphite particles is:
(i) greater than about 99.92 wt % Cg; or
(ii) between about 99.95 to 99.97 wt % Cg.

57. The composite anode material of claim 49, wherein the graphite particles are provided in the form of:
(i) synthetic graphite; or
(ii) natural graphite with a high crystalline structure.

58. The composite anode material of claim 49, wherein the external amorphous carbon shell further comprises:
(i) one or more oxides; or
(ii) Al₂O₃, TiO₂, ZrO₂, BaTiO₃, MgO, CuO, ZnO, Fe₂O₃, GeO₂, Li₂O, MnO, NiO, or zeolite, or any combination thereof.

59. An anode composite comprising a composite anode material as claimed in claim 49.

60. A method for the production of a composite anode material, the method comprising the method steps of:
(i) subjecting a graphitic material in the form of graphite particles that have a D₅₀ of less than about 10 μm to a coating step in which the graphitic material is coated with a carbon matrix to prepare a plurality of carbon coated graphite particles;
(ii) passing the product of step (i) to a shaping step to produce shaped composites; and
(iii) thermally treating the composites of step (ii), thereby producing a composite anode material comprising a plurality of carbon coated graphitic particles, wherein each graphite particle is held within the carbon matrix and about which is provided an amorphous carbon shell, wherein the composite anode material has a D₅₀ of about 3.5 to 5 μm.

61. The method of claim 60, wherein the graphitic material is provided in the form of graphite particles that have a D₅₀ of less than about 6 μm.

62. The method of claim 60, wherein the carbon matrix is:
(i) pitch; or
(ii) about 2-10 wt % pitch.

63. The method of claim 60, wherein the composite anode material has a D₅₀ of about 4.7 μm.

64. The method of claim 60, wherein the composite anode material has a surface area (BET):
(i) in the range of about 4 to 7 m²/g; or
(ii) of about 4.4 m²/g.

65. The method of claim 60, wherein the purity of the graphitic material is:
(i) greater than about 99.92 wt % Cg; or
(ii) between about 99.95 to 99.97 wt % Cg.

66. The method of claim 60, wherein the graphitic material is provided in the form of:
(i) synthetic graphite; or
(ii) natural graphite with a high crystalline structure.

67. The method of claim 60, wherein alloy materials are added to the composite anode material.

68. The method of claim 60, wherein the external amorphous carbon shell further comprises:
(i) one or more oxides; or
(ii) Al₂O₃, TiO₂, ZrO₂, BaTiO₃, MgO, CuO, ZnO, Fe₂O₃, GeO₂, Li₂O, MnO, NiO, or zeolite, or any combination thereof.

69. The method of claim 60, wherein the thermal treatment of step (iii) is provided in the form of pyrolysis.

70. The method of claim 60, wherein the method further comprises a classification step.

71. The method of claim 70, wherein the classification step is performed:
(i) before the coating step of step (i); or
(ii) following the thermal treatment of step (iii).

72. The method of claim 60, wherein the thermal treatment of step (iii) is conducted at a temperature in the range of about 850° C. to 1100° C.

73. The method of claim 60, wherein the thermal treatment step (iii) comprises a profile of heating, holding at temperature, and cooling.

74. The method of claim 73, wherein the thermal treatment step (iii) comprises about 8.5 hours heating, about 4 hours holding at 1100° C., and about 5 to 10 hours cooling.

75. The method of claim 60, wherein the graphitic material is classified into more than one fraction, with a fraction below about 1 to 2 μm being cut and the remaining fraction being utilised in step (i).

76. The method of claim 75, wherein the remaining fraction is screened to remove particles greater than about 30 μm prior to being utilised in step (i).

77. The method of claim 60, wherein the method further comprises a final classification step to remove any composite anode material of greater than about 30 μm.

78. The method of claim 60, wherein the carbon matrix is pitch and the pitch is:
(i) milled to a powder prior to contact with the graphitic material in the coating step; or
(ii) milled to a powder having a P₈₀ of about 2 μm prior to contact with the graphitic material in the coating step.
